(19) United States
(12) Patent Application Publication
(10) Pub. No.: US 2025/0142271 A1
(43) Pub. Date: May 1, 2025

(54) HEARING INSTRUMENT CONFIGURED TO IMPLEMENT A BEHAVIORAL DIAGNOSTIC

(71) Applicant: Starkey Laboratories, Inc., Eden Prairie, MN (US)

(72) Inventors: Dave Fabry, Eden Prairie, MN (US); Christopher Larry Howes, Eden Prairie, MN (US); Hugh Anthony Cregg, III, Stevensville, MT (US)

(21) Appl. No.: 18/906,732

(22) Filed: Oct. 4, 2024

Related U.S. Application Data
(60) Provisional application No. 63/545,876, filed on Oct. 26, 2023.

(51) Int. Cl. H04R 25/00

(52) U.S. Cl. CPC H04R 25/70; H04R 2225/39; H04R 2225/55

(57) ABSTRACT

A hearing instrument comprises a processor coupled to memory, a user interface operatively coupled to the processor, one or more microphones, and an acoustic transducer. Audio processing circuitry is coupled to the one or more microphones, the acoustic transducer, and the processor. The processor is configured to deliver, via the acoustic transducer, a series of supra-threshold audio stimuli to an ear of the wearer, receive, from the wearer via the user interface, an indication of the quality of perception of the stimuli, and store the indication of the quality of perception in the memory. The processor can be configured to present the indication of the quality of perception of the stimuli via the user interface. The user interface can be implemented by the hearing instrument or an external electronic device communicatively coupled to the hearing instrument.

### CROSS REFERENCE TO RELATED APPLICATIONS

This application claims the benefit of 63/545,876, filed Oct. 26, 2023, the disclosure of which is incorporated by reference herein in its entirety.

### TECHNICAL FIELD

The present disclosure relates to hearing instruments and, more particularly, to such instruments configured to implement a behavioral diagnostic to determine whether a wearer of the hearing instrument is realizing the full benefit of hearing enhancement from the hearing instrument.

### SUMMARY

Some embodiments are directed to a method implemented by a hearing instrument worn by a wearer. The method comprises delivering, via the hearing instrument, a series of supra-threshold audio stimuli to an ear of the wearer. The method also involves receiving, from the wearer via a user interface, an indication of the quality of perception of the stimuli. The method further involves storing the indication of the quality of perception in an electronic memory. The method may comprise presenting the indication of the quality of perception of the stimuli via the user interface. The user interface can be implemented by the hearing instrument or an external electronic device communicatively coupled to the hearing instrument.

Some embodiments are directed to a hearing instrument configured to be worn by a wearer. The hearing instrument comprises a processor coupled to memory, a user interface operatively coupled to the processor, one or more microphones, and an acoustic transducer. Audio processing circuitry is coupled to the one or more microphones, the acoustic transducer, and the processor. The processor is configured to deliver, via the acoustic transducer, a series of supra-threshold audio stimuli to an ear of the wearer, receive, from the wearer via the user interface, an indication of the quality of perception of the stimuli, and store the indication of the quality of perception in the memory. The processor can be configured to present the indication of the quality of perception of the stimuli via the user interface. The user interface can be implemented by the hearing instrument or an external electronic device communicatively coupled to the hearing instrument.

### BRIEF DESCRIPTION OF THE DRAWINGS

Illustrative embodiments will be further described with reference to the figures of the drawing, wherein:

FIG. 1 is a system block diagram of a hearing instrument configured to perform a behavioral diagnostic in accordance with any of the embodiments disclosed herein;

FIG. 2 is a flowchart illustrating a method involving a behavioral diagnostic in accordance with any of the embodiments disclosed herein;

FIG. 3 illustrates plots of three different supra-threshold audio stimuli that can be played to the wearer of a hearing instrument as part of a behavioral diagnostic in accordance with any of the embodiments disclosed herein;

FIG. 4 illustrates plots of five different supra-threshold audio stimuli that can be played to the wearer of a hearing instrument as part of a behavioral diagnostic in accordance with any of the embodiments disclosed herein;

FIG. 5 illustrates plots of five different supra-threshold audio stimuli that can be played to the wearer of a hearing instrument as part of a behavioral diagnostic in accordance with any of the embodiments disclosed herein; and

FIG. 6 illustrates a method involving a behavioral diagnostic in accordance with any of the embodiments disclosed herein.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following detailed description of illustrative embodiments, reference is made to the accompanying figures of the drawing which form a part hereof. It is to be understood that other embodiments, which may not be described and/or illustrated herein, are certainly contemplated.

Embodiments disclosed herein are directed to a hearing instrument configured to implement a behavioral diagnostic to determine whether a wearer of the hearing instrument is realizing the full benefit of hearing enhancement from the hearing instrument. A hearing instrument, as depicted in the figures and described herein, is intended to demonstrate the subject matter, but not in a limited, exhaustive, or exclusive sense.

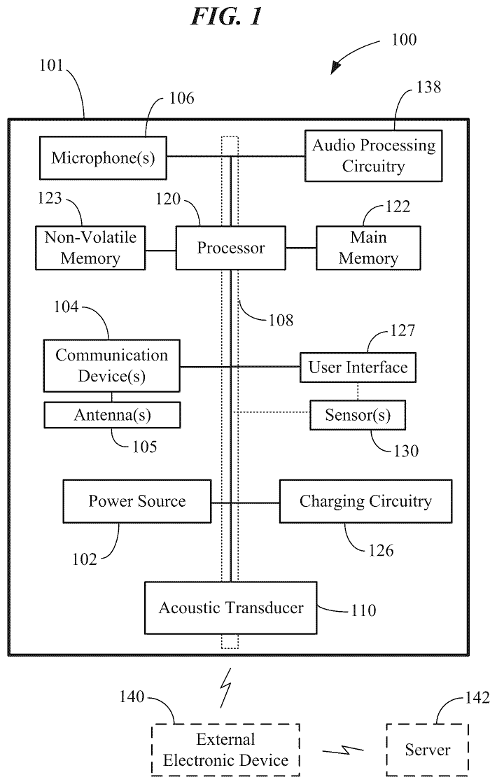

FIG. 1 is a block diagram that illustrates a hearing instrument 100 in accordance with any of the embodiments disclosed herein. The hearing instrument 100 includes a housing 101 configured to be worn at or in an ear of a wearer. The hearing instrument 100 shown in FIG. 1 can represent a single hearing instrument configured for monaural or single-ear operation or one of a pair of hearing instruments configured for binaural or dual-ear operation. The housing 101 contains or supports various components, representative examples of which are shown in FIG. 1.

The hearing instrument 100 includes a processor 120 operatively coupled to a main memory 122 and a non-volatile memory 123. The processor 120 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC).

The processor 120 can include or be operatively coupled to main memory 122, such as RAM (e.g., DRAM, SRAM). The processor 120 can include or be operatively coupled to non-volatile memory 123, such as ROM, EPROM, EEPROM or flash memory. The non-volatile memory 123 is configured to store program instructions executable by the processor 120 for controlling and implementing various operations performed by the hearing instrument 100. The processor 120 is configured to implement a behavioral diagnostic according to the functionality illustrated in the figures and described herein. The non-volatile memory 123 is also configured to store data produced by the hearing instrument 100 when performing a behavioral diagnostic, as will be described hereinbelow.

The hearing instrument 100 includes an audio processing facility operably coupled to, or incorporating, the processor 120. The audio processing facility includes audio signal processing circuitry 138 (e.g., analog front-end, analog-to-digital converter, digital-to-analog converter, DSP, and various analog and digital filters), a microphone arrangement 106, and an acoustic transducer 110 (e.g., a speaker or receiver). The microphone arrangement 106 can include one or more discrete microphones or a microphone array(s) (e.g., configured for microphone array beamforming). Each of the microphones of the microphone arrangement 106 can be situated at different locations of the housing 101. The microphone arrangement 106 is configured to monitor the acoustic environment of the hearing instrument wearer, as well as the wearer's own voice (which can serve as a user input). It is understood that the term microphone used herein can refer to a single microphone or multiple microphones.

The hearing instrument 100 also includes a user interface 127 operatively coupled to the processor 120. The user interface 127 can include one or more user-actuatable controls (e.g., push-buttons, capacitive switches, a gesture detection sensor). The user interface 127 is configured to receive an input from the wearer of the hearing instrument 100. The input from the wearer can be any type of user input, such as a touch input, a gesture input, or a voice input (via the microphone arrangement 106).

The user interface 127 can include, or be coupled to, one or more sensors 130. For example, the sensors 130 can include an accelerometer or inertial measurement unit (IMU) configured to detect finger taps applied to the housing 101 of the hearing instrument 100. The processor 120 can interpret the wearer's input based on a number of factors, including the number of taps and the time duration between taps (e.g., short versus long durations between taps). The accelerometer or IMU can also detect head nodding and shaking by the wearer as user inputs (e.g., a head nod =yes, a head shake =no).

One or more of the sensors 130 can be configured to obtain physiological information (e.g., physiological state or condition) of the wearer. The sensors 130 can include one or more of a heart rate sensor, a temperature sensor (e.g., a thermistor, thermocouple, resistance temperature detector), and a blood oxygen saturation sensor (e.g., a photoplethysmography or PPG sensor). The one or more physiological sensors can be components of the user interface 127 or be connected to the processor 120.

The hearing instrument 100 can include one or more communication devices 104 coupled to one or more antennas 105. For example, the one or more communication devices 104 can include one or more radios that conform to an IEEE 802.11 (e.g., WiFi®) or Bluetooth® e.g., BLE) specification, for example. In addition, or alternatively, the hearing instrument 100 can include a near-field magnetic induction (NFMI) sensor (e.g., an NFMI transceiver coupled to a magnetic antenna) for effecting short-range communications (e.g., ear-to-ear communications).

In some implementations, the hearing instrument 100 is configured to communicate with an external electronic device 140, such as a smartphone, tablet or other personal digital assistant, via a communication device 104. The external electronic device 140 can communicate with a server 142, e.g., via a network/the Internet. Behavioral diagnostic data produced by the hearing instrument 100 can be communicated to the server 142, which can be configured to store the data and/or perform analyses on the data. The behavioral diagnostic data may be stored with timestamps, environmental information, and/or other contextual information. Results from the data analyses can be communicated from the server 142 to the external electronic device 140 for presentation to the wearer (e.g., via a display and/or audio output, and/or tactile output).

The hearing instrument 100 also includes a power source 102, which can be a conventional battery, a rechargeable battery (e.g., a lithium-ion battery), or a power source comprising a supercapacitor. The power source 102 is operably coupled to power management circuitry for supplying power to various components of the hearing instrument 100. In embodiments which include a rechargeable power source 102, charging circuity 126 is coupled to the rechargeable power source 102. The charging circuitry 126 is electrically coupled to charging contacts on the housing 101 which are configured to electrically couple to corresponding charging contacts of a charging unit (e.g., a charging case) when the hearing instrument 100 is placed in the charging unit. The various electrical and electronic components of the hearing instrument 100 shown in FIG. 1 can be electrically connected or coupled by way of a flexible printed circuit board 108.

The term hearing instrument refers to a wide variety of electronic devices configured for deployment in, on or about an ear of a wearer. Representative hearing instruments of the present disclosure include, but are not limited to, in-the-canal (ITC), completely-in-the-canal (CIC), invisible-in-canal (IIC), in-the-ear (ITE), receiver-in-canal (RIC), behind-the-ear (BTE), and receiver-in-the-ear (RITE) type devices. Representative hearing instruments of the present disclosure include, but are not limited to, earbuds, electronic ear plugs, personal sound amplification devices, and other ear-wearable electronic appliances. Hearing instruments of the present disclosure include restricted medical devices (e.g., devices regulated by the U.S. Food and Drug Administration), such as hearing aids. Hearing instruments of the present disclosure include consumer electronic devices, such as consumer earbuds, consumer sound amplifiers, and consumer hearing devices (e.g., consumer hearing aids and over-the-counter (OTC) hearing devices), for example.

Hearing perception can vary from day to day. In a person with Meniere's disease, for example, hearing can fluctuate from day to day, and can change overnight without warning. Hearing perception can change significantly due to exposure to loud sounds (e.g., blaring music at a rock concert, an air or fog horn). Exposure to loud sounds can result in an auditory temporary threshold shift (e.g., temporary hearing loss). Symptoms of temporary threshold shift typically subside after several hours, but can last for days in some cases. Taking certain medications can result in varying degrees of hearing loss. Taking aspirin in high doses (e.g., 8-12pills a day) may cause hearing loss. Non-steroidal anti-inflammatory drugs, such as ibuprofen and naproxen, in high doses, may cause hearing loss. Certain antibiotics, such as aminoglycosides, may cause hearing loss. Other drugs, such as platinum-containing chemotherapy drugs and loop diuretics, may cause hearing loss.

In view of these and other considerations, a wearer of a hearing instrument may perceive to have a hearing experience that changes from day to day or over an extended duration of time. Information about what a hearing instrument wearer is perceiving can be useful for the hearing instrument system, the wearer, or a professional or other person in an effort to improve the hearing experience for the wearer.

According to any of the embodiments disclosed herein, a hearing instrument can be configured to implement a behavioral diagnostic which allows the wearer of the hearing instrument to assess their perception of sounds generated by the hearing instrument. When performing a behavioral diagnostic, the hearing instrument plays audio stimuli (sounds) that are known to the wearer so that the wearer can assess their perception of the expected sounds. The sounds, for example, can be one or more of musical tones (e.g., synthesized or tones from sampled music), music snippets, and speech (e.g., pre-recorded speech or speech of the wearer or someone known to the wearer). The behavioral diagnostic provides information to the wearer, or a caregiver or hearing professional, about whether the wearer is getting the full benefit of hearing enhancement from the hearing instrument.

A test or series of tests implemented by a hearing instrument may help validate that the wearer is getting the full benefit of the hearing instrument. The test or tests can assess whether the wearer's hearing may have changed (e.g., deteriorated or improved). The test or tests can assess whether the hearing instrument may be malfunctioning or affected by foreign material (e.g., ear wax). A hearing instrument may enable a technologically-assisted check of a wearer's hearing experience, i.e., the wearer's perception of sound.

In a representative example, the hearing instrument may sweep through a range of frequencies (e.g., from low to high) and through a range of amplitudes (e.g., from quiet to loud but comfortable) to check the wearer's perception of sounds across the frequency spectrum and amplitude spectrum. In an example configuration, the hearing instrument may perform frequency sweeps (low frequency to high frequency) at different amplitudes. In another example configuration, the hearing instrument may perform amplitude tests (e.g., low volume through high but comfortable volume) at different frequencies. The sweeps may be followed by a recognizable sound or signature (e.g., a sequence of mid-frequency, mid-amplitude sounds) so that the wearer knows whether some sound is “missing” (imperceptible) through the sweep.

The behavioral diagnostic may be implemented by a hearing instrument using supra-threshold audio stimuli to assess whether a particular audio stimulus sounds as it should, is uncomfortable (too loud), or imperceptible (too soft) or otherwise unacceptable. A test of the present disclosure that uses supra-threshold audio stimuli is in contrast to a threshold test, which is performed above and below the perception threshold to assess the hearing threshold for different frequencies for a particular individual. The behavioral diagnostic can test the two main components of audition that the wearer is concerned with, namely, the range of frequencies and the range of amplitudes. The supra-threshold stimuli may be designed to capture the range of frequencies and amplitudes that are relevant for the wearer. The wearer may receive training, through a professional (e.g., an audiologist) or through a smartphone app, so that the wearer knows what to expect during the behavioral diagnostic.

Embodiments of the disclosure are defined in the claims. However, below there is provided a non-exhaustive listing of non-limiting examples. Any one or more of the features of these examples may be combined with any one or more features of another example, embodiment, or aspect described herein.

Example Ex1. A method, implemented by a hearing instrument worn by a wearer, comprises delivering, via the hearing instrument, a series of supra-threshold audio stimuli to an ear of the wearer, receiving, from the wearer via a user interface, an indication of the quality of perception of the stimuli, and storing the indication of the quality of perception in an electronic memory.

Example Ex2. The method of Ex1, wherein the supra-threshold audio stimuli comprise predetermined sounds that vary in frequency and intensity and are known to be perceivable by the wearer.

Example Ex3. The method of Ex2, wherein the predetermined sounds vary in frequency across a specified frequency spectrum and vary in intensity between soft, moderate, and loud but comfortable amplitudes.

Example Ex4. The method of Ex1, wherein the supra-threshold audio stimuli are customized for an audiogram of the wearer.

Example Ex5. The method of Ex1, wherein the quality of perception of the stimuli comprises the presence or amount of distortion or noise perceived by the wearer.

Example Ex6. The method of Ex1, wherein the method is performed for each ear individually.

Example Ex7. The method of Ex1, comprising presenting the indication of the quality of perception of the stimuli via the user interface.

Example Ex8. The method of Ex1, comprising computing a trend of indications of the quality of perception of the stimuli, and presenting the trend via the user interface.

Example Ex9. The method of Ex8, comprising determining whether the trend indicates that the quality of perception of the stimuli is stable, improving, or degrading.

Example Ex10. The method of Ex1, comprising monitoring, via the hearing instrument, for exposure to loud sounds sufficient to cause an auditory temporary threshold shift, and alerting the wearer, via the user interface, to avoid further exposure to loud sounds for a specified duration of time.

Example Ex11. The method of Ex1, comprising analyzing indications of the quality of perception of the stimuli in combination with information resulting from one or more events impacting the wearer, determining a relationship between a change in the indications and the one or more events, and presenting information about the relationship via the user interface.

Example Ex12. The method of Ex1, comprising analyzing indications of the quality of perception of the stimuli in combination with physiological data acquired from the wearer, determining a relationship between a change in the indications and a change of the physiological data, and presenting information about the relationship via the user interface.

Example Ex13. The method of Ex1, comprising analyzing indications of the quality of perception of the stimuli in combination with pharmaceutical data acquired for the wearer, assessing an effectiveness or side-effect of a pharmaceutical regimen based on a change in the indications, and presenting information about the assessment via the user interface.

Example Ex14. The method of Ex1, comprising concurrently performing a test of the hearing instrument's hardware using the audio stimuli.

Example Ex15. The method of Ex1, wherein the user interface comprises a sensor of

the hearing instrument, and receiving the indication comprises receiving the indication using the sensor.

Example Ex16. The method of Ex15, wherein the sensor comprises an accelerometer or an inertial measurement unit (IMU).

Example Ex17. The method of Ex1, wherein the user interface comprises a touch display of an external electronic device, and receiving the indication comprises receiving the indication via the touch display.

Example Ex18. The method of Ex1, wherein the user interface comprises a microphone of the hearing instrument, and receiving the indication comprises receiving the indication as a vocal response using the microphone.

Example Ex19. The method of Ex1, wherein the indication of the quality of perception is stored in the electronic memory of the hearing instrument, an external electronic memory, or both.

Example Ex20. A hearing instrument configured to be worn by a wearer comprises a processor coupled to memory, a user interface operatively coupled to the processor, one or more microphones, an acoustic transducer, and audio processing circuitry coupled to the one or more microphones, the acoustic transducer, and the processor. The processor is configured to deliver, via the acoustic transducer, a series of supra-threshold audio stimuli to an ear of the wearer, receive, from the wearer via the user interface, an indication of the quality of perception of the stimuli, and store the indication of the quality of perception in the memory.

Example Ex21. The hearing instrument of Ex20, wherein the supra-threshold audio stimuli comprise predetermined sounds that vary in frequency and intensity and are known to be perceivable by the wearer.

Example Ex22. The hearing instrument of Ex21, wherein the predetermined sounds vary in frequency across a specified frequency spectrum and vary in intensity between soft, moderate, and loud but comfortable amplitudes.

Example Ex23. The hearing instrument of Ex20, wherein the supra-threshold audio stimuli are customized for an audiogram of the wearer.

Example Ex24. The hearing instrument of Ex20, wherein the quality of perception of the stimuli comprises the presence or amount of distortion or noise perceived by the wearer.

Example Ex25. The hearing instrument of Ex20, wherein the processor is configured to present the indication of the quality of perception of the stimuli via the user interface.

Example Ex26. The hearing instrument of Ex20, wherein the processor is configured to compute a trend of indications of the quality of perception of the stimuli, present the trend via the user interface.

Example Ex27. The hearing instrument of Ex26, wherein the processor is configured to determine whether the trend indicates that the quality of perception of the stimuli is stable, improving, or degrading.

Example Ex28. The hearing instrument of Ex20, wherein the processor is configured

to monitor, via the one or more microphones, for exposure to loud sounds sufficient to cause an auditory temporary threshold shift, and alert the wearer, via the user interface, to avoid further exposure to loud sounds for a specified duration of time.

Example Ex29. The hearing instrument of Ex20, wherein the processor is configured

to analyze indications of the quality of perception of the stimuli in combination with information resulting from one or more events impacting the wearer, determine a relationship between a change in the indications and the one or more events, and present information about the relationship via the user interface.

Example Ex30. The hearing instrument of Ex20, comprising one or more physiological sensors coupled to the processor, wherein the processor is configured to analyze indications of the quality of perception of the stimuli in combination with physiological data acquired by the one or more physiological sensors, determine a relationship between a change in the indications and a change of the physiological data, and present information about the relationship via the user interface.

Example Ex31. The hearing instrument of Ex20, wherein the processor is configured to analyze indications of the quality of perception of the stimuli in combination with pharmaceutical data acquired for the wearer via the user interface, assess an effectiveness or side-effect of a pharmaceutical regimen based on a change in the indications, and present information about the assessment via the user interface.

Example Ex32. The hearing instrument of Ex20, wherein the processor is configured to concurrently perform a test of the hearing instrument's hardware using the audio stimuli.

Example Ex33. The hearing instrument of Ex20, wherein the user interface comprises a sensor, and the processor is configured to receive the indication of the quality of perception of the stimuli using the sensor.

Example Ex34. The hearing instrument of Ex33, wherein the sensor comprises an accelerometer or an inertial measurement unit (IMU).

Example Ex35. The hearing instrument of Ex20, wherein the user interface comprises a touch display of an external electronic device, and the processor is configured to receive the indication of the quality of perception of the stimuli via the touch display.

Example Ex36. The hearing instrument of Ex20, wherein the processor is configured to receive the indication of the quality of perception of the stimuli as a vocal response using the one or more microphones.

Example Ex37. The hearing instrument of Ex20, wherein the processor is configured to store the indication of the quality of perception of the stimuli in the memory of the hearing instrument, an external electronic memory, or both.

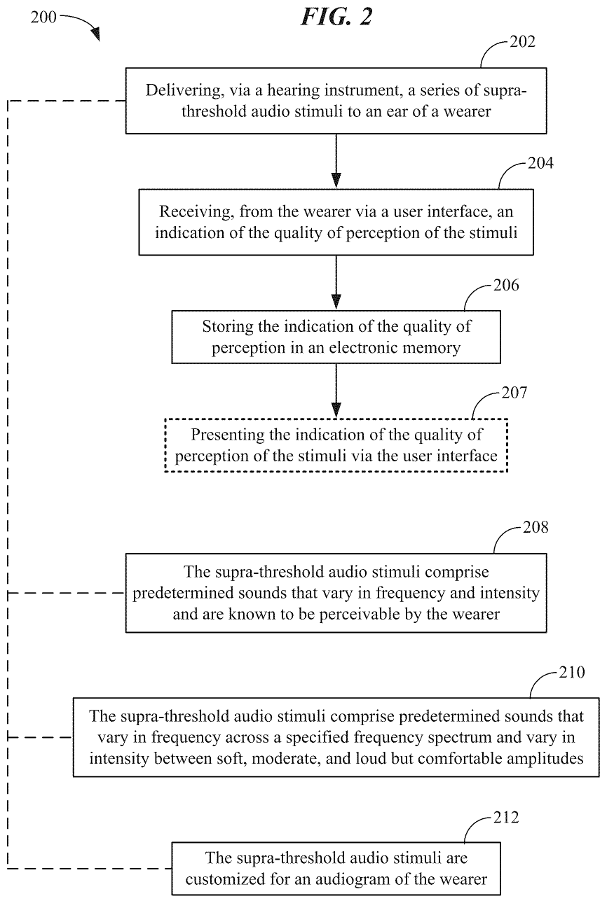

FIG. 2 is a flowchart illustrating a method involving a behavioral diagnostic in accordance with any of the embodiments disclosed herein. The method shown in FIG. 2 involves delivering 202, via a hearing instrument, a series of supra-threshold audio stimuli to an ear of a wearer of the hearing instrument. The method also involves receiving 204, from the wearer via a user interface, an indication of the quality of perception of the audio stimuli. The method further involves storing 206 the indication of the quality of perception in an electronic memory.

In some implementations, the indication of the quality of perception of the audio stimuli can be stored in an electronic memory of the hearing instrument. In other implementations, the indication of the quality of perception of the audio stimuli can be stored in an electronic memory of an external electronic device (e.g., a smartphone or tablet) communicatively coupled to the hearing instrument. The quality of perception data can be communicated from the external electronic device to a server, which can perform various analyses using the quality of perception data. Results from the analyses can be communicated from the server to the external electronic device. The method shown in FIG. 2 may involve presenting 207 the indication of the quality of perception of the audio stimuli via a user interface of the hearing instrument and/or a user interface of an external electronic device communicatively coupled to the hearing instrument.

As is further illustrated in FIG. 2, the supra-threshold audio stimuli 208 can comprise predetermined sounds that vary in frequency and intensity and are known to be perceivable by the wearer. For example, the supra-threshold audio stimuli 210 can comprise predetermined sounds that vary in frequency across a specified frequency spectrum and vary in intensity between soft, moderate, and loud but comfortable amplitudes. In some implementations, the supra-threshold audio stimuli 212 are customized for an audiogram of the wearer.

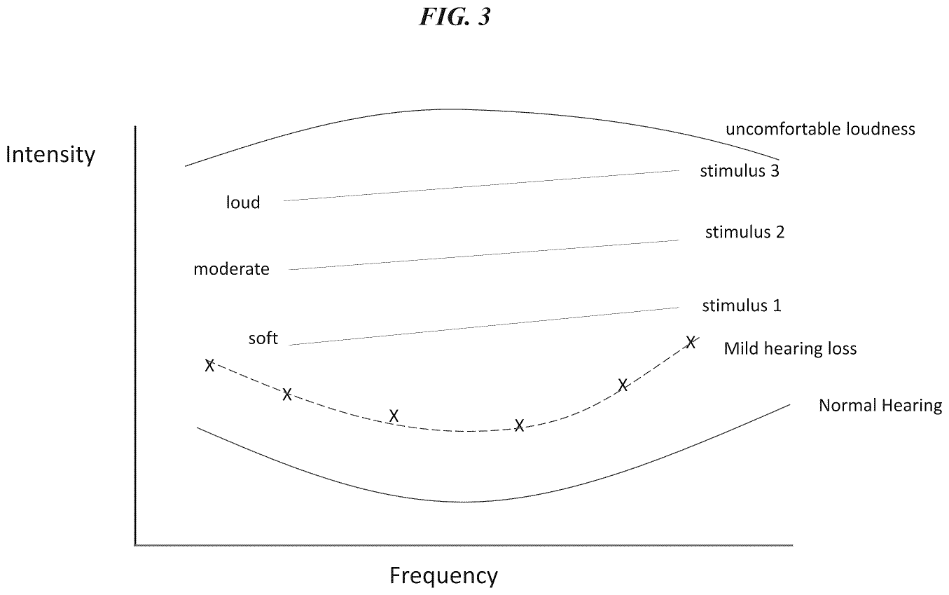

FIG. 3 illustrates plots of three different supra-threshold audio stimuli that can be played to the wearer of a hearing instrument as part of a behavioral diagnostic in accordance with any of the embodiments disclosed herein. In this illustrative example, the wearer of the hearing instrument has mild hearing loss, which is indicated by the dashed curve relative to a curve associated with normal hearing. Each of the three audio stimuli varies in terms of frequency and intensity at a level between the mild hearing loss curve, as a lower bound, and an uncomfortable loudness curve, as an upper bound. The hearing loss curve and uncomfortable loudness curve can be established through testing by a hearing professional or via an app executed by a smartphone or tablet communicatively coupled to the hearing instrument.

Stimulus 1 is representative of a soft sound that varies continuously in intensity and frequency. The soft sound (stimulus 1) is bounded by the mild hearing loss curve and the moderate line/curve. Stimulus 2 is representative of a moderate sound that varies continuously in intensity and frequency. The moderate sound is bounded by the soft sound line/curve and the loud but comfortable line/curve. Stimulus 3 is representative of a loud but comfortable sound that varies continuously in intensity and frequency. The loud but comfortable sound is bounded by the moderate line/curve and the uncomfortable loudness curve. In some implementations, the intensity of the three audio stimuli can be held constant at soft, moderate, and loud but comfortable levels while the frequency is continuously varied. Each of the three audio stimuli is known to be perceivable by the wearer of the hearing instrument.

In the case where the wearer uses a left hearing instrument and a right hearing instrument, the behavioral diagnostic is performed by each of the hearing instruments individually (e.g., one at a time). The three audio stimuli are played to the wearer individually (e.g., one at a time). According to some implementations, the behavioral diagnostic can be initiated by first playing a soft sound (stimulus 1) then awaiting an input by the wearer that indicates whether or not the soft sound was perceived. The wearer's input can be received by the hearing instrument (e.g., a touch input, a voice input, a gesture input) or an external electronic device communicatively coupled to the hearing instrument (see examples below). Next, the moderate sound (stimulus 2) can be played followed by an input by the wearer that indicates whether or not the moderate sound was perceived. Lastly, the loud but comfortable sound (stimulus 3) can be played followed by an input by the wearer that indicates whether or not the loud but comfortable sound was perceived and considered comfortable. The inputs received from the wearer constitute an indication of the quality of perception of the audio stimuli. The inputs received from the wearer can be stored in an electronic memory of the hearing instrument and/or the external electronic device.

In other implementations, the three audio stimuli are played to the wearer individually in sequence. Rather than awaiting an input by the wearer after playback of each audio stimulus, the behavioral diagnostic awaits an input by the wearer after playing the three audio stimuli in sequence. For example, the wearer's input can indicate that all three audio stimuli were perceived or that all audio stimuli were not perceived. In another example, the wearer's input can indicate the number of audio stimuli that was or was not perceived. In a further example, the wearer's input can indicate which audio stimuli were not perceived (e.g., by indicating the stimulus/stimuli by number).

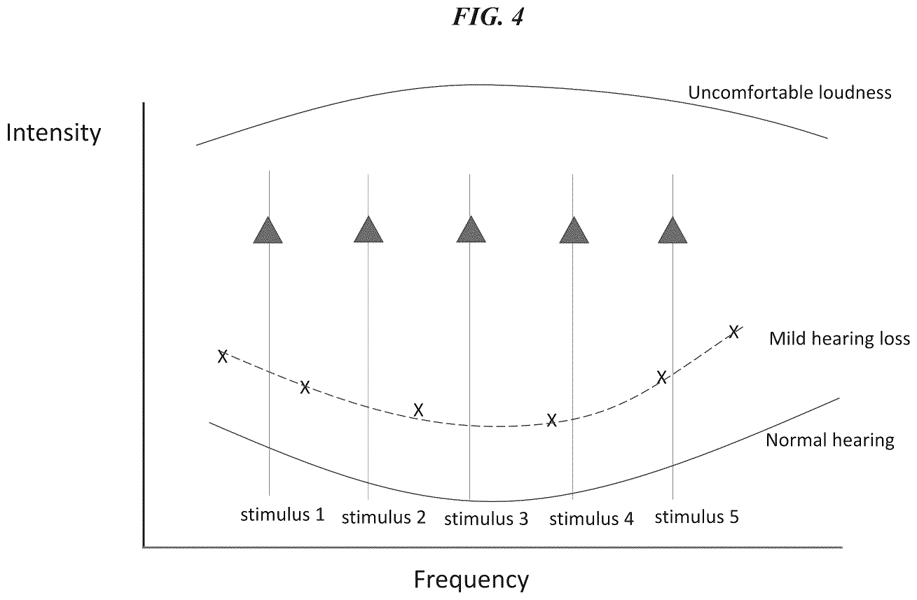

FIG. 4 illustrates plots of five different supra-threshold audio stimuli that can be played to the wearer of a hearing instrument as part of a behavioral diagnostic in accordance with any of the embodiments disclosed herein. As in the previous example, the behavioral diagnostic is implemented by a single hearing instrument playing each of the five different audio stimuli individually. In this illustrative example, each of the audio stimuli has a different frequency (e.g., fixed frequency) and is played to the wearer at the same intensity (e.g., a moderate or loud but comfortable intensity above the mild hearing loss curve). Each of the five audio stimuli is played at an intensity level and frequency between a mild hearing loss curve (dashed curve), as a lower bound, and an uncomfortable loudness curve, as an upper bound. In some implementations, the intensity of sound played to the wearer can be varied at each of the five frequencies. For example, the intensity can be varied between soft, moderate, and loud but comfortable levels at each of the five frequencies. Each of the five audio stimuli is known to be perceivable by the wearer of the hearing instrument.

In some implementations, the behavioral diagnostic causes each of the five audio stimuli to be played individually to the wearer. After playing an audio stimuli, the behavioral diagnostic awaits an input by the wearer that indicates whether or not the audio stimuli was perceived. The wearer's input can be received by the hearing instrument or an external electronic device communicatively coupled to the hearing instrument. The process of playing an audio stimuli and receiving an indication of the quality of perception of each stimuli from the wearer is repeated for each of the five audio stimuli. The inputs received from the wearer can be stored in an electronic memory of the hearing instrument and/or the external electronic device.

In other implementations, the five audio stimuli are played to the wearer individually in sequence. Rather than awaiting an input by the wearer after playback of each audio stimulus, the behavioral diagnostic awaits an input by the wearer after playing the five audio stimuli in sequence. For example, the wearer's input can indicate that all five audio stimuli were perceived or that all audio stimuli were not perceived. In another example, the wearer's input can indicate the number of audio stimuli that was or was not perceived. In a further example, the wearer's input can indicate which audio stimuli were not perceived (e.g., by indicating the stimulus/stimuli by number).

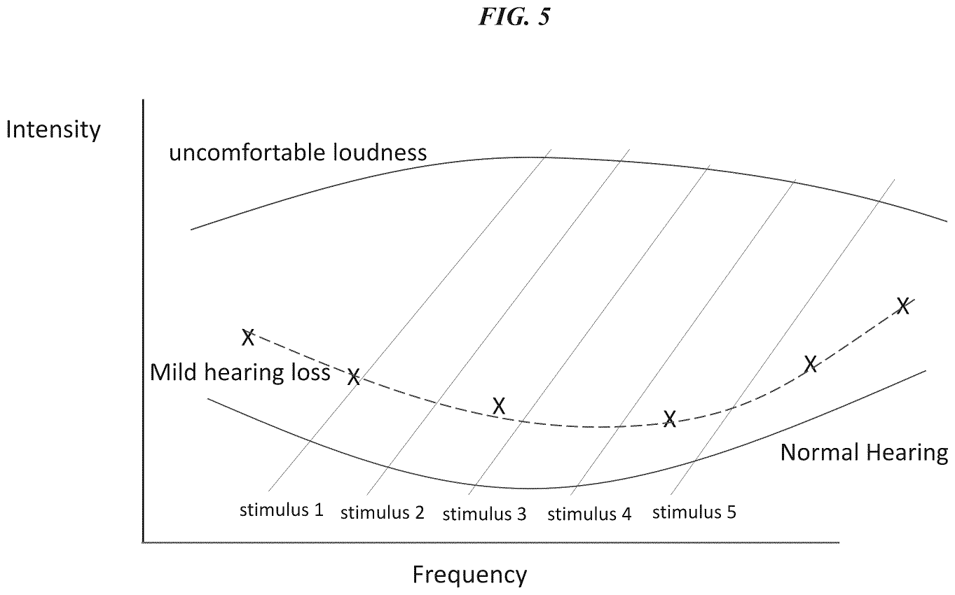

FIG. 5 illustrates plots of five different supra-threshold audio stimuli that can be played to the wearer of a hearing instrument as part of a behavioral diagnostic in accordance with any of the embodiments disclosed herein. As in the previous examples, the behavioral diagnostic is implemented by a single hearing instrument playing each of the five different audio stimuli individually. In this illustrative example, each of the audio stimuli has a frequency and intensity which vary concurrently in a continuous manner. Stimulus 1 has the lowest frequency range, while stimulus 5 has the highest frequency range. As the frequency is increased (e.g., swept) for each stimulus, the intensity is also increased (e.g., swept). Each of the five audio stimuli is played at an intensity level between a mild hearing loss curve (dashed curve), as a lower bound, and an uncomfortable loudness curve, as an upper bound. Each of the five audio stimuli is known to be perceivable by the wearer of the hearing instrument.

In some implementations, the behavioral diagnostic causes each of the five audio stimuli to be played individually to the wearer. After playing an audio stimuli, the behavioral diagnostic awaits an input by the wearer that indicates whether or not the audio stimuli was perceived. The wearer's input can be received by the hearing instrument or an external electronic device communicatively coupled to the hearing instrument. The process of playing an audio stimuli and receiving an indication of the quality of perception of each stimuli from the wearer is repeated for each of the five audio stimuli. The inputs received from the wearer can be stored in an electronic memory of the hearing instrument and/or the external electronic device.

In other implementations, the five audio stimuli are played to the wearer individually in sequence. Instead of awaiting an input by the wearer after playback of each audio stimulus, the behavioral diagnostic awaits an input by the wearer after playing the five audio stimuli in sequence. As an example, the wearer's input can indicate that all five audio stimuli were perceived or that all five audio stimuli were not perceived. In another example, the wearer's input can indicate the number of audio stimuli that was or was not perceived. In a further example, the wearer's input can indicate which audio stimuli were not perceived.

The audio stimuli delivered by the hearing instrument and corresponding input or responses received from the wearer are designed to check the wearer's perception of sound, as opposed to merely checking the operation of the hearing instrument's hardware. For example, the wearer's response to delivered audio stimuli can be an indication of how many sounds were heard (e.g., four out of five). The wearer's response to delivered audio stimuli can be an indication of a particular point in the sequence of audio stimuli delivery that resulted in a problem or failure, or in wearer discomfort (e.g., the fourth and fifth sounds in the sequence of audio stimuli were not perceptible, the third sound was too loud). The wearer's response to a delivered audio stimulus can be a binary indication of Yes (the sound was heard) or No (the sound was not heard). The hearing instrument can detect a head gesture to indicate the wearer's response to a delivered audio stimulus, such as a head nod to indicate the sound was heard or a head shake to indicate that the sound was not heard.

The wearer's response to a delivered audio stimulus can be a vocal indication of “Yes” (the sound was heard), “Good” (the sound was good), “No” (the sound was not heard), or “Bad” (the sound was bad/distorted/noisy) received by a microphone of the hearing instrument. An audio query by the hearing instrument can be played after delivery of each audio stimulus to query whether each sound was heard by the wearer (e.g., “did you hear the third sound?”). After delivering a series of audio stimuli (e.g., a series of three sounds, a series of five sounds), the hearing instrument can listen for a vocal indication from the wearer. For example, the hearing instrument can receive an audio input such as “all sounds were heard,” “I heard all three sounds,” “I couldn't hear the fifth sound,” or “the loud sound was uncomfortable.”

The user interface of the hearing instrument can include a touch sensor (e.g., an accelerometer, IMU) that can detect a number of taps applied to the hearing instrument, such that the number of taps corresponds to the number of sounds heard by the wearer (e.g., three out of five sounds heard resulting in three taps). In another example, a touch input can be received by the hearing instrument after playing each audio stimulus, such that a double tap indicates that the wearer heard the stimulus and a single tap indicates that the wearer did not hear the stimulus. In a further example, a first touch input (e.g., a double tap) can be detected by the hearing instrument after playing a sequence of audio stimuli indicating that the hearing experience was as expected, whereas a second touch input (e.g., a single tap) indicates that the hearing experience was not as expected.

In some implementations, a response of a wearer to audio stimuli played by the hearing instrument can be received by an external electronic device, such as a smartphone or tablet. The external electronic device can be configured to communicatively couple to the hearing instrument and execute an app that allows the wearer to indicate the quality of perception of the audio stimuli delivered during a behavioral diagnostic. The behavioral diagnostic can be initiated in response to a touch input (e.g., touching of a start button) applied to a touchscreen of the external electronic device. After playing each of the audio stimuli, a textual query can be presented on the display to determine whether the audio stimuli was heard by the wearer. A response from the wearer may be indicated through a selection of buttons on the touchscreen. For example, the wearer can tap a Yes button to indicate that the audio stimulus was heard or tap a No button to indicate the audio stimulus was not heard. This process can be repeated for each audio stimulus delivered by the hearing instrument.

In some implementations, a verbal query can be played to the wearer after delivery of audio stimuli via a speaker of the external electronic device. A response from the wearer to each verbal query may be indicated by a verbal utterance (e.g., a “Yes” utterance to indicate the sound was heard, a “No” utterance to indicate the sound was not heard) detected by a microphone of the external electronic device or the hearing instrument.

In other implementations, a textual or verbal query can be presented to the wearer after delivery of audio stimuli via the external electronic device and a response to each query can be detected by a camera of the external electronic device. For example, the camera can capture a thumbs-up or smile response by the wearer to indicate a Yes response to the query. The camera can capture a thumbs-down or frown response by the wearer to indicate a No response to the query. As another example, the camera can capture a nod movement of the wearer's head to indicate a Yes response to the query, and a shake movement of the wearer's head to indicate a No response to the query.

In further implementations, a textual or verbal query can be presented to the wearer after delivery of audio stimuli via the external electronic device and a response to each query can be detected by an IMU of the external electronic device. A first type of device movement can indicate that an audio stimulus was heard by the wearer, while a second type of device movement can indicate that the audio stimulus was not heard by the wearer. For example, moving the external electronic device in the elevation plane (a forward and backward motion) by the wearer can indicate a Yes response to the query. Moving the external electronic device in the azimuthal plane (e.g., a shaking motion) by the wearer can indicate a No response to the query.

In the representative examples provided above, a query is presented to the wearer after delivery of audio stimuli to determine whether or not the audio stimuli was heard by the wearer. It is understood that, in some implementations, a query need not be presented to the wearer, and the wearer need only provide a response after delivery of the audio stimuli.

According to some implementations, the behavioral diagnostic process may be performed on one hearing instrument at a time, so as to check perception in the left ear and right ear independently. For example, audio stimuli may be provided sequentially to one ear and then the other, or alternately to the left ear and the right ear (e.g., low freq. left ear, low freq. right ear, medium freq. left ear, medium freq. right ear, and so on).

The behavioral diagnostic may be administered responsive to a wearer request via an input to the hearing instrument or an external electronic device communicatively coupled to the hearing instrument. The behavioral diagnostic may be administered automatically upon hearing instrument startup or it may be initiated according to a schedule or as part of a reminder system. The behavioral diagnostic may be administered in response to an assessment of an acoustic environment (e.g., a quiet environment), wearer activity (e.g., resting or at least not exercising or driving), or other contextual information. The behavioral diagnostic may be administered based on any combination of the scenarios listed above (e.g., based on a schedule or reminder in combination with an appropriate state of wearer activity or environment or both).

The hearing instrument or the external electronic device can be configured to sample, record, and/or analyze the ambient acoustic environment for reference as part of the behavioral diagnostic. For example, the hearing instrument or the external electronic device can record sound within the wearer's ambient environment and perform a classification of the sound. A number of different sounds in the ambient environment can be classified, including speech, non-speech, music, machine noise, and wind noise, such as in the manner described in commonly-owned U.S. Patent Publication No. 2020/0152227, which is incorporated herein by reference. The hearing instrument or the external electronic device can record a sound snippet or decibel level from the wearer's ambient environment. The acoustic environment information can be stored with the behavioral diagnostic data.

The acoustic environment information can also be used to determine whether the behavioral diagnostic can be successfully executed. For example, the acoustic environment information may indicate that the wearer's acoustic environment is too noisy to reliably implement the behavioral diagnostic. The hearing instrument or external electronic device can inform the wearer that the behavioral diagnostic should be executed at a later time when the noise subsides in the acoustic environment.

As previously discussed, behavioral diagnostic data and, optionally, related information (e.g., environment or contextual data) can be transferred from the hearing instrument to an external electronic device which may transfer the data to a server. The external electronic device or the server can be configured to perform analyses on the transferred data (e.g., to determine a pattern of the behavioral diagnostic data). For example, a trend of wearer responses acquired during behavioral diagnostic testing performed over time can be computed by the external electronic device or the server. The trend can be used to determine whether the wearer may be suffering from progressive hearing loss. For example, the trend can indicate that the quality of wearer perception of the audio stimuli is stable, improving, or degrading. Trend information can be communicated to the wearer via the user interface of the external electronic device or via audio output from the hearing instrument.

The analyses of the behavioral diagnostic data and, optionally, related information can be used by the hearing instrument to make an adjustment to compensate for a change in wearer hearing or comfort, or a change in hearing instrument performance. For example, analysis of the behavioral diagnostic data may indicate that the wearer often does not hear a soft, high-frequency sound during testing. The hearing instrument can compensate by increasing the high frequency response of the hearing instrument. As another example, analysis of the behavioral diagnostic data may indicate that loud sounds produced by the hearing instrument during behavioral diagnostic testing is often uncomfortable for the wearer. The hearing instrument can compensate by decreasing the high amplitude response of the hearing instrument.

The analyses of the behavioral diagnostic data and, optionally, related information can be used to recommend a course of action by the wearer. The course of action can be communicated to the wearer via the user interface of the external electronic device or audio output from the hearing instrument. The course of action can be a recommendation that the wearer perform a hearing instrument self-check or to schedule an appointment with a hearing or service professional.

A hearing instrument self-check can be performed using a charging case which is configured to charge a power source of the hearing instrument. The charging case includes a processor coupled to memory which stores programmed instructions which, when executed by the processor, implements a self-check protocol for testing hardware components of a pair of hearing instruments. According to a representative self-check protocol, left and right hearing instruments are placed in the charging case. The self-check protocol can be initiated automatically (e.g., by closing a lid of the charging case) or in response to a wearer input (e.g., via the user interface of the external electronic device). Various measurements can be made, including one or more of acoustic, electrical, optical, thermal, and mechanical measurements. These measurements can be compared against nominal performance information and any deviations can be recorded. Results of the self-check protocol can be transmitted from the hearing instruments to the external electronic device, which can include recommendations for addressing sub-optimal performance of one or both of the hearing instruments (e.g., contacting a hearing or service professional).

A representative self-check protocol involves detecting presence of a first hearing instrument and a second hearing instrument in a charging case (e.g., in response to a lid sensor close signal). The self-check protocol involves wirelessly coupling the first and second hearing instruments, and selectively activating at least one hardware component of the first hearing instrument. The self-check protocol involves assessing performance of the second hearing instrument using an output or a response of the at least one hardware component of the first device. Wirelessly coupling the first and second hearing instruments can comprise one or more of electromagnetically, capacitively, inductively, magnetically, acoustically, and optically coupling the first and second hearing instruments.

The self-check protocol also involves selectively activating at least one hardware component of the second hearing instrument. The self-check protocol further involves assessing performance of the first hearing instrument using an output or a response of the at least one hardware component of the second device. Results of the performance assessment can be stored in the memory of the hearing instruments and, additionally or optionally, in memory of the charging case. Results of the performance assessment can be communicated to an external electronic device or system (e.g., a smartphone, tablet, wireless access point, the cloud). The hardware component or components subject to testing can be any hearing instrument component disclosed herein (e.g., a microphone, speaker, receiver, sensor). Details of a representative self-check protocol that can be implemented by hearing instruments of the present disclosure are disclosed in commonly-owned U.S. Patent Publication No. 2022/0408199, which is incorporated herein by reference.

According to another self-check protocol, an in-situ hardware self-check can be performed concurrently with execution of a behavioral diagnostic. According to a representative testing protocol, one or a pair of hearing instruments are worn by the wearer. Each hearing instrument can play a sequence of sounds (e.g., tones) via a speaker or receiver, and assess a response to the sounds via a microphone of the hearing instrument. The test sounds may be designed to capture the range of frequencies and amplitudes that are relevant for the wearer and the hearing instrument. At least some of the test sounds are sounds perceivable by the wearer for purposes of performing the behavioral diagnostic in a manner previously described. Some test sounds may be designed to test the speaker/receiver and microphone of the hearing instrument and may be inaudible to the wearer.

For example, a sequence of seven test sounds can be played to the wearer as part of the concurrent hardware self-check and behavioral diagnostic. Two of the seven test sounds may be low-frequency sounds that are inaudible to the wearer but can be sensed by a microphone of the hearing instrument. The next three test sounds may be perceivable by the wearer (see, e.g., FIG. 3) and are used by the behavioral diagnostic to test the wearer's current hearing perception. The next two test sounds may be high-frequency sounds that are inaudible to the wearer but can be sensed by the microphone of the hearing instrument.

The response of the microphone to the test sounds can be compared to nominal performance information (e.g., a performance profile or specification) stored in memory of the hearing instrument. Any significant deviations can be recorded by the hearing instrument. The deviations may indicate that the microphone is defective, the speaker/receiver is defective, or both components are defective. In response to any significant deviations, an alert message can be communicated from the hearing instrument to an external electronic device. The alert message can be accompanied by a recommendation to contact a hearing or service professional to address the hardware deficiency.

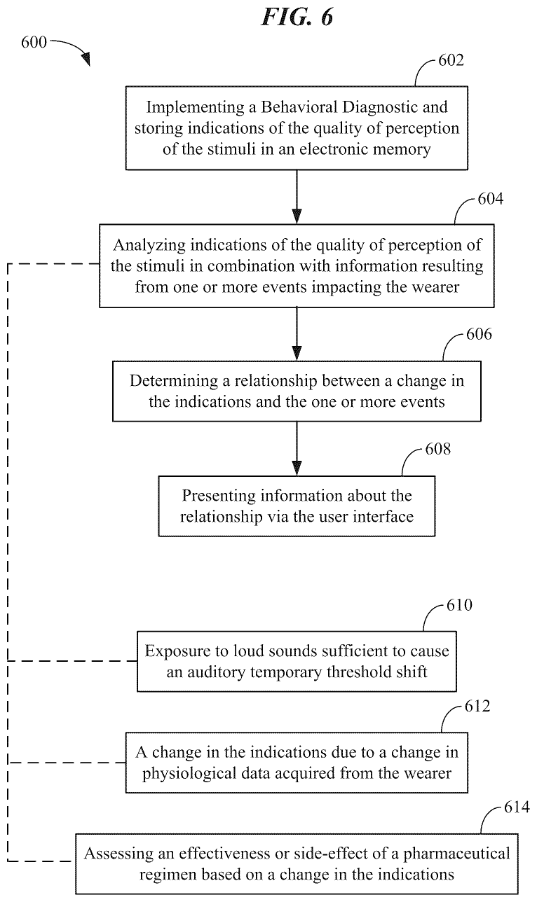

FIG. 6 illustrates a method involving a behavioral diagnostic in accordance with any of the embodiments disclosed herein. The method shown in FIG. 6 involves implementing 602 a behavioral diagnostic and storing indications of the quality of perception of the audio stimuli in an electronic memory, such as in the manner shown in FIG. 2. The method involves analyzing 604 indications of the quality of perception of the stimuli in combination with information resulting from one or more events impacting the wearer. A representative event involves exposure 610 to loud sounds sufficient to cause an auditory temporary threshold shift. Another representative event involves a change 612 in the indications due to a change in physiological data acquired from the wearer. A further representative event involves assessing 614 an effectiveness or side-effect of a pharmaceutical regimen based on a change in the indications. Representative examples of these scenarios are provided below.

During normal use, a hearing instrument can be configured to monitor for exposure to loud sounds sufficient to cause an auditory temporary threshold shift. As discussed previously, hearing perception can change significantly due to exposure to loud sounds, which can lead to temporary hearing loss. The hearing instrument can compare sounds sensed by the hearing instrument's microphone to a high intensity threshold to determine if the received sounds are sufficient to cause auditory temporary threshold shift. In response to exceeding the high intensity threshold, the wearer can be alerted by the hearing instrument or an external electronic device communicatively coupled to the hearing instrument to avoid further exposure to loud sounds for a specified duration of time (e.g., 24 hours).

A behavioral diagnostic can be implemented after detection of a wearer's exposure to loud sounds to determine whether the wearer's perception of audio stimuli is diminished due the loud sound exposure event. In this regard, the hearing instrument is configured to determine a relationship between a change in the wearer's perception of audio stimuli and the loud sound exposure event. For example, the behavioral diagnostic may reveal that the wearer's perception of soft, high-frequency sounds was diminished after being exposed to the loud sounds. The hearing instrument or an external electronic device can alert the wearer of the change in the wearer's perception of sound and that the change is possibly caused by exposure to loud sounds. Additionally, a recommendation can be communicated to the wearer to perform another behavioral diagnostic within the next day or two.

According to some implementations, a hearing instrument may combine behavioral diagnostic data with physiological information. Physiological information may include information obtained using a sensor on the hearing instrument. The hearing instrument can include one or more physiological sensors, such as a heart rate sensor, a temperature sensor, and/or a blood oxygen saturation sensor (e.g., a PPG sensor). The physiological information may additionally or alternatively include information from an external sensor system, such as a scale, blood pressure cuff, or other sensor communicatively coupled to a network via a Bluetooth™, WiFi™, wire, or other connection.

The behavioral diagnostic data and physiological information can be analyzed by the hearing instrument or an external electronic device or server communicatively coupled to the hearing instrument. The analysis may reveal whether a relationship exists between a change in the wearer's perception of sound and a change of the physiological data. Information about this relationship can be presented to the wearer via a user interface of the hearing device or the external electronic device.

As was previously discussed, taking certain medications can result in varying degrees of hearing loss. A behavioral diagnostic app running on an external electronic device can provide for wearer input of pharmaceutical data, such as the wearer's medications and the time of day the medications are taken. The behavioral diagnostic data and pharmaceutical data can be analyzed by the hearing instrument or an external electronic device or server communicatively coupled to the hearing instrument. The analysis may reveal an association between a change in the wearer's perception of sound and an effectiveness or side-effect of a pharmaceutical regimen of the wearer. For example, the wearer's perception of sound may become diminished after taking a drug prescribed to the wearer. Information about this relationship can be presented to the wearer via a user interface of the hearing device or the external electronic device.

All references and publications cited herein are expressly incorporated herein by reference in their entirety into this disclosure, except to the extent they may directly contradict this disclosure. Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g. 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality (for example, a radio chip may be operably coupled to an antenna element to provide a radio frequency electric signal for wireless communication).

Terms related to orientation, such as “top,” “bottom,” “side,” and “end,” are used to describe relative positions of components and are not meant to limit the orientation of the embodiments contemplated. For example, an embodiment described as having a “top” and “bottom” also encompasses embodiments thereof rotated in various directions unless the content clearly dictates otherwise.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

1. A hearing instrument configured to be worn by a wearer, comprising:
a processor coupled to memory;
a user interface operatively coupled to the processor;
one or more microphones;
an acoustic transducer; and
audio processing circuitry coupled to the one or more microphones, the acoustic transducer, and the processor, wherein the processor is configured to:
deliver, via the acoustic transducer, a series of supra-threshold audio stimuli to an ear of the wearer;
receive, from the wearer via the user interface, an indication of the quality of perception of the stimuli; and
store the indication of the quality of perception in the memory.

2. The hearing instrument of claim 1, wherein the supra-threshold audio stimuli comprise predetermined sounds that vary in frequency and intensity and are known to be perceivable by the wearer.

3. The hearing instrument of claim 2, wherein the predetermined sounds vary in frequency across a specified frequency spectrum and vary in intensity between soft, moderate, and loud but comfortable amplitudes.

4. The hearing instrument of claim 1, wherein the supra-threshold audio stimuli are customized for an audiogram of the wearer.

5. The hearing instrument of claim 1, wherein the quality of perception of the stimuli comprises the presence or amount of distortion or noise perceived by the wearer.

6. The hearing instrument of claim 1, wherein the processor is configured to present the indication of the quality of perception of the stimuli via the user interface.

7. The hearing instrument of claim 1, wherein the processor is configured to:
compute a trend of indications of the quality of perception of the stimuli; and
present the trend via the user interface.

8. The hearing instrument of claim 7, wherein the processor is configured to determine whether the trend indicates that the quality of perception of the stimuli is stable, improving, or degrading.

9. The hearing instrument of claim 1, wherein the processor is configured to:
analyze indications of the quality of perception of the stimuli in combination with information resulting from one or more events impacting the wearer;
determine a relationship between a change in the indications and the one or more events; and
present information about the relationship via the user interface.

10. The hearing instrument of claim 1, comprising one or more physiological sensors coupled to the processor, wherein the processor is configured to:
analyze indications of the quality of perception of the stimuli in combination with physiological data acquired by the one or more physiological sensors;
determine a relationship between a change in the indications and a change of the physiological data; and
present information about the relationship via the user interface.

11. The hearing instrument of claim 1, wherein the processor is configured to:
analyze indications of the quality of perception of the stimuli in combination with pharmaceutical data acquired for the wearer via the user interface;
assess an effectiveness or side-effect of a pharmaceutical regimen based on a change in the indications; and
present information about the assessment via the user interface.

12. The hearing instrument of claim 1, wherein the processor is configured to concurrently perform a test of the hearing instrument's hardware using the audio stimuli.

13. The hearing instrument of claim 1, wherein:
the user interface comprises a sensor;
the processor is configured to receive the indication of the quality of perception of the stimuli using the sensor; and
the sensor comprises an accelerometer or an inertial measurement unit (IMU).

14. The hearing instrument of claim 1, wherein:
the user interface comprises a touch display of an external electronic device; and
the processor is configured to receive the indication of the quality of perception of the stimuli via the touch display.

15. The hearing instrument of claim 1, wherein the processor is configured to receive the indication of the quality of perception of the stimuli as a vocal response using the one or more microphones.

16. The hearing instrument of claim 1, wherein the processor is configured to store the indication of the quality of perception of the stimuli in the memory of the hearing instrument, an external electronic memory, or both.

17. A method implemented by a hearing instrument worn by a wearer, comprising:
delivering, via the hearing instrument, a series of supra-threshold audio stimuli to an ear of the wearer;
receiving, from the wearer via a user interface, an indication of the quality of perception of the stimuli; and
storing the indication of the quality of perception in an electronic memory.

18. The method of claim 17, wherein:
the supra-threshold audio stimuli comprise predetermined sounds that vary in frequency and intensity and are known to be perceivable by the wearer; and
the predetermined sounds vary in frequency across a specified frequency spectrum and vary in intensity between soft, moderate, and loud but comfortable amplitudes.

19. The method of claim 17, wherein the supra-threshold audio stimuli are customized for an audiogram of the wearer.

20. The method of claim 17, wherein the quality of perception of the stimuli comprises the presence or amount of distortion or noise perceived by the wearer.

21. The method of claim 17, comprising presenting the indication of the quality of perception of the stimuli via the user interface.

22. The method of claim 17, comprising:
computing a trend of indications of the quality of perception of the stimuli;
determining whether the trend indicates that the quality of perception of the stimuli is stable, improving, or degrading; and
presenting the trend via the user interface.

23. The method of claim 17, wherein the indication of the quality of perception is stored in the electronic memory of the hearing instrument, an external electronic memory, or both.
